(19) United States
(12) Patent Application Publication
(10) Pub. No.: US 2008/0305787 A1
(43) Pub. Date: Dec. 11, 2008

(54) System, vehicle unit and cellular phone for vehicular short range wireless communication

(75) Inventors: Yasufumi Yamada, Okazaki-city (JP); Yasuyuki Itoh, Ichinomiya-city (JP); Hideki Sakoh, Kariya-city (JP); Tetsuya Oki, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/153,828

(22) Filed: May 27, 2008

(30) Foreign Application Priority Data
Jun. 6, 2007 (JP) 2007-150347

(51) Int. Cl. H04Q 7/20

(52) U.S. Cl. 455/426.1

(57) ABSTRACT

An administration management system for managing vehicles includes plural vehicle units and plural cellular phones respectively having common codes for correspondence between vehicle units and cellular phones. When the common code matches, the vehicle unit and the cellular phone perform an automatic connection procedure and administration management information acquired by the vehicle unit is transmitted to a center unit through a broad range network from the cellular phone. The cellular phone and the vehicle unit are prevented from being connected with each other in an erroneous manner without undergoing complicated connection procedure so as to establish appropriate communication for transmission of administration management information by using the common code assigned thereto.

### CROSS REFERENCE TO RELATED APPLICATION

The present application is based on and claims the benefit of priority of Japanese Patent Application No. 2007-150347 filed on Jun. 6, 2007, the disclosure of which is incorporated herein by reference.

### FIELD OF THE INVENTION

The present disclosure generally relates to a system, vehicle unit and cellular phone for vehicular short range wireless communication.

### BACKGROUND INFORMATION

Conventionally, a terminal having a Bluetooth (Registered trademark) communication function detects a device ID and a profile type of Bluetooth connectable device and displays the device ID of a predetermined type for user's disposal so as to enable selective connection to one of the Bluetooth connectable devices under control of a user (refer to Japanese patent document JP-A-2002-290416, for example). Further, a connecting device having an RFID reader performs radio-frequency communication with and a portable communication terminal having a transponder for acquiring communication setting data from the terminal, and establishes WLAN communication with the portable communication terminal based on the acquired communication setting data (refer to Japanese patent document JP-A-2006-287767, for example).

In addition, an administration management system used in a collection and delivery business has, for example, a vehicle unit and a cellular phone that are configured to transmit administration management information acquired by the vehicle unit to a center unit through a broad range communication network from the cellular phone. In this case, the vehicle unit and the cellular phone must establish one-to-one communication channel therebetween, and the one-to-one communication can be established by using, for example, a wire cable that connects the vehicle unit and the cellular phone.

However, problematic connection between the vehicle unit and the cellular phone is caused when the vehicle unit and the cellular phone are connected through wireless connection for communication. That is, for example, one vehicle unit is simultaneously connected to plural cellular phones, or a vehicle unit is connected to a cellular phone that should not normally be connected. Further, an additional complicated connection procedure may be required for preventing the erroneous connection as a preventive measure for causing more hassles and troubles for a user. The disclosures of the above patent documents do not provide a solution for the problem.

### SUMMARY OF THE INVENTION

In view of the above and other problems, the present disclosure provides a system, a vehicle unit and a cellular phone for vehicular short range wireless communication that appropriately connects the cellular phone and the vehicle unit in a corresponding manner through wireless communication by using a short range communication function.

The system for vehicular short range wireless communication of the present invention includes: a plurality of cellular phones respectively having a short range communication function; and a plurality of vehicle units respectively having a short range communication function. One of the plurality of the cellular phones and one of the plurality of the vehicle units respectively existing in a short range communication range executes an automatic connection procedure for automatic connection based on configuration, and the plurality of the cellular phones and the plurality of the vehicle units respectively have a common code in common with a connection partner. Further, the common code from the connection partner is examined and determined to be identical with the common code in a subject device before executing the automatic connection procedure with the connection partner.

The system configuration described above enables the cellular phone and the vehicle unit respectively having the matching common code can automatically executing an automatic connection procedure without performing a complicated erroneous connection prevention procedure, thereby enabling an establishment of correct wireless connection of the cellular phone and the vehicle unit in an appropriate manner. Particularly, even when the combination of the cellular phone and the vehicle unit is changed in a daily basis (i.e., when the cellular phone is brought into a different vehicle such as a delivery truck day by day) in a vehicle management system implemented in, for example, a collection and delivery business or the like, the frequent change of the combination of the cellular phone and the vehicle unit can be efficiently managed by the system of the present invention in an accurate manner.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a total configuration of an administration service system in a first embodiment of the present invention;

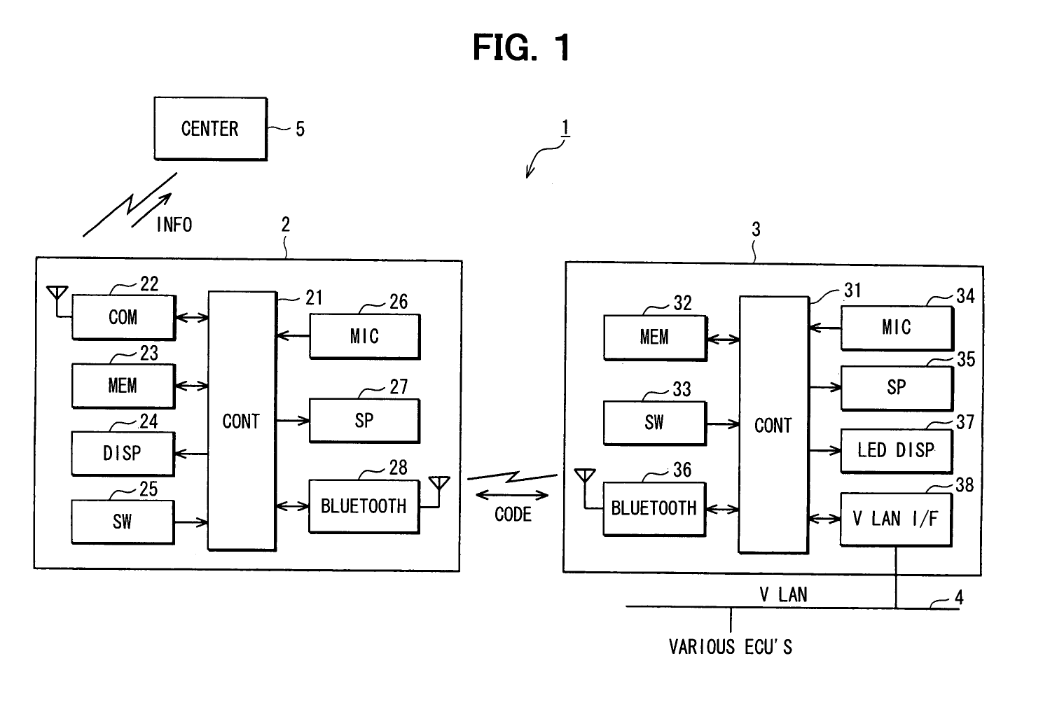

FIG. 2 shows an illustration of a common code assignment in the first embodiment;

FIG. 3 shows a flowchart of a process performed in a cellular phone in the first embodiment;

FIG. 4 shows a flowchart of a process performed in a vehicle unit in the first embodiment;

FIG. 5 shows an illustration of an action of a worker schematically drawn relative to an office and vehicles in the first embodiment;

FIG. 6 shows correspondence between cellular phones and vehicle units in the first embodiment;

FIG. 7 shows a an illustration of a common code assignment in a second embodiment of the present invention;

FIG. 8 shows correspondence between cellular phones and vehicle units in the second embodiment;

### DETAILED DESCRIPTION

### First Embodiment

The first embodiment of the present invention is described as an implementation to an administration service system for delivery and collection business in the following. In the present embodiment, the short distance wireless communication is assumed to be Bluetooth (a registered trademark) communication.

The administration service system 1 includes a portable telephone 2 with a short distance wireless communication function (i.e., designated as cellular phone 2 in the following) that a worker collecting and delivering baggage carries, and a vehicle unit 3 with the short distance wireless communication function (i.e., designated as a vehicle unit in the following) installed on a vehicle (for example, a truck) that the worker loads the baggage into.

Each of the short range communication function equipped cellular phones 2 and the vehicle units 3 have Bluetooth communication function, and when both of the cellular phone 2 and the vehicle unit 3 are within the range of Bluetooth communication, an automatic connection procedure is carried out, and the cellular phone 2 and the vehicle unit 3 can be connected automatically. For example, the cellular phones 2 are put in the offices of the distribution center, and the vehicle carrying the vehicle unit 3 parks at a truck yard. In this case, the worker picks up one of plural cellular phones 2 in the office, and goes to the truck yard with the cellular phone 2, and departs for delivery/collection from the truck yard by driving one of the trucks that is specified beforehand with the cellular phone 2 brought into the truck (the truck may be determined according to a predetermined work schedule of the day).

The cellular phone,2 has a control unit 21 (a common code determination unit of the portable telephone in claiming context) controlling the operation of the whole unit, a telephone communications unit 22 for a broad range communication, a memory unit 23 (a common code memory unit of the portable telephone in claiming context) to memorize various information that at least include a common code, a display unit 24 displaying various information, a switch 25 that a worker operates, a microphone 26 inputting a sound, a speaker 27 outputting a sound, and a Bluetooth communications unit 28 (a common code reception unit and an automatic connection unit of the portable telephone in claiming context).

The vehicle unit 3 has a control unit 31 (a common code determination unit of the vehicle unit in claiming context) controlling the operation of the whole unit, a memory unit 32 (a common code memory unit of the vehicle unit in claiming context) to memorize various information that at least include a common code, a switch 33 that a worker operates, a microphone 34 inputting a sound, a speaker 35 outputting a sound, a Bluetooth communications unit 36 (a common code reception unit and an automatic connection unit of the vehicle unit in claiming context) controlling the operation of the whole Bluetooth communication, an LED display unit 37 a vehicle LAN interface 38 to connect to a vehicle LAN 4. In addition, the vehicle unit 3 links, for example, ON/OFF of an ACC switch of the vehicle with ON/OFF of a power supply, and operates the control unit 31 and the Bluetooth communications unit 36 in lowered power in a waiting condition when the ACC switch of the vehicle is turned off for shutting the power supply.

When the cellular phone 2 and the vehicle unit 3 are in an auto-connected condition after performing an automatic connection procedure, the vehicle unit 3 acquires vehicle information (a current position, a vehicle speed and a course) through the vehicle LAN 4 from various ECUs, and transmits, through the Bluetooth communications unit 36 to the cellular phone 2, the acquired vehicle information together with the collection and delivery information about the collection and delivery situation that, for example, a worker inputs by using the switch 25, as service management information. Further, the cellular phone 2 receives the service management information transmitted from the vehicle unit 3 by The Bluetooth communications unit 28, the received service management information is transmitted to a center unit 5 through a wide area communications network from telephone communications unit 22.

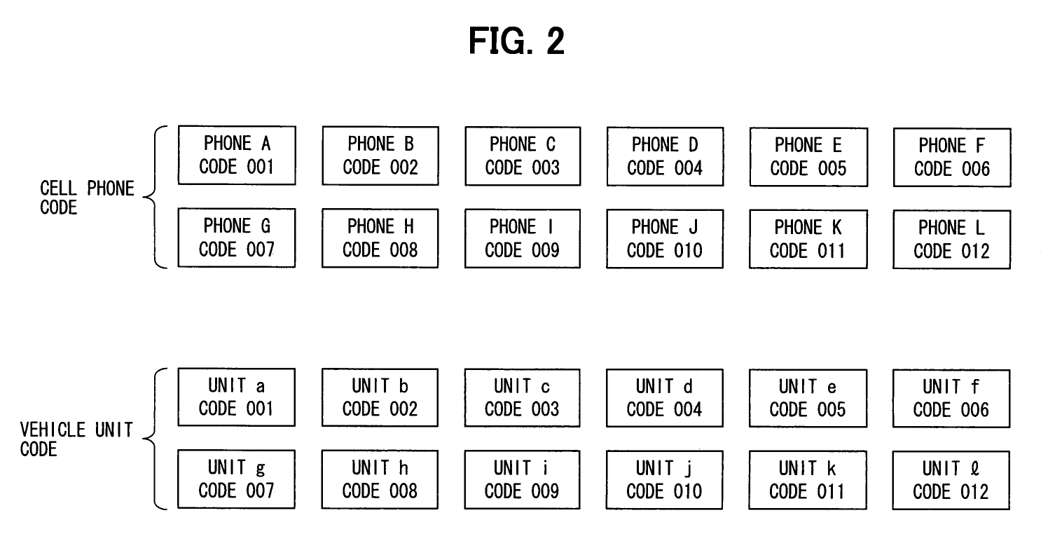

The common code mentioned above is a code that is commonly assigned to the cellular phone 2 and to the vehicle unit 3 in the case. More practically, the situation is described with reference to FIG. 2. That is, the plural cellular phones 2 are depicted as twelve cellular phones A to L, and the plural vehicle units 3 are depicted as twelve vehicle units a to I as an example. A common code ‘001’ is assigned to a cellular phone A and to a vehicle unit a, a common code ‘002’ is assigned to a cellular phone B and to a vehicle unit b, a common code ‘003’ is assigned to a cellular phone C and to a vehicle unit c, and so on, to be concluded with a common code ‘012’ being assigned to a cellular phone L and to a vehicle unit I. In other words, each of the cellular phones and each of the vehicle units respectively have a common code in a one-to-one manner. In addition, these common codes are different from the common code assigned to the cellular phone which the worker owns personally.

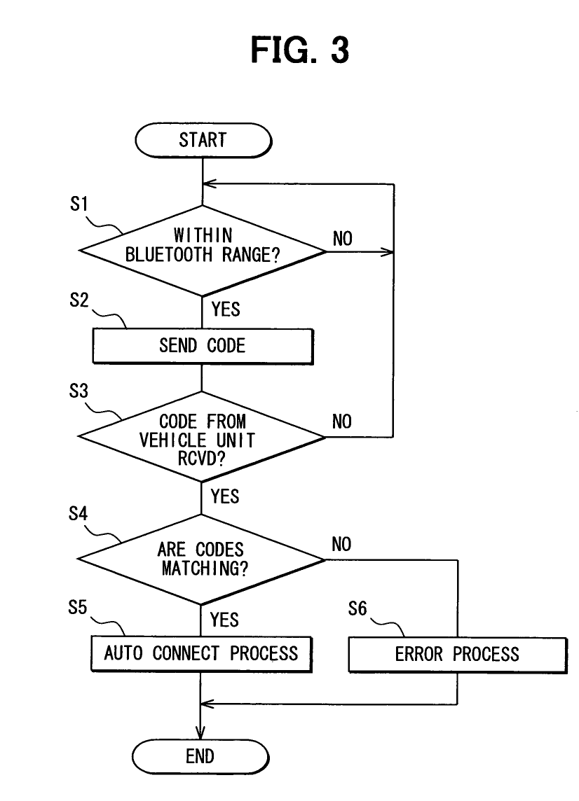

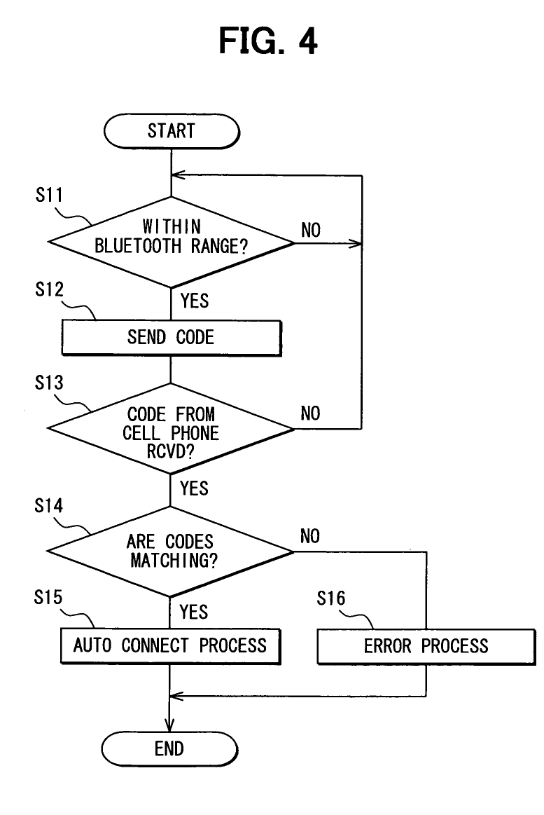

Effect of configuration mentioned above is explained referring to FIGS. 3 to 6. FIG. 3 shows a flowchart of a process in the Bluetooth communications unit 28 of the cellular phone 2, and FIG. 4 shows a flowchart of a process that the Bluetooth communications unit 36 of the vehicle unit 3 performs.

At first, in the cellular phone 2, the Bluetooth communications unit 28 carries out the following processing. That is, when the cellular phone 2 the power supply being turned on, the Bluetooth communications unit 28 determines whether there is a cellular phone 2 and a vehicle unit 3 within the range of Bluetooth communication (step Si). If a worker carrying the cellular phone 2 approaches one of the vehicles to be within the Bluetooth communication range, the Bluetooth communications unit 28 determines that the cellular phone 2 and the vehicle unit 3 are within the range of Bluetooth communication (step S1:YES), and controls the control unit 21 to acquire a common code by reading the code from the memory unit 23, and transmits the code acquired from the memory unit 23 to the vehicle unit 3 (step S2). In this case, the Bluetooth communications unit 28 transmits a common code to the vehicle unit 3 by assigning a common code to an area of the name code which a user can arbitrarily set besides areas of a machinery ID and a profile classification.

Subsequently, the Bluetooth communications unit 28 determines whether a common code from the vehicle unit 3 is received (step S3), and after determining that the common code from the vehicle unit 3 is received (step S3:YES), the unit 28 controls the control unit 21 to determine whether the code received from the vehicle unit 3, that is, the common code assigned to the vehicle unit 3 which is within the range of Bluetooth communication, and the code from the memory unit 23 match with each other (step S4).

Then, the Bluetooth communications unit 28 inputs a determination result from the control unit 21, and an affirmative result that both codes match with each other (step S4:YES) leads to carrying out an automatic connection procedure (step S5), and a series of processing is finished. In contrast, when the Bluetooth communications unit 28 inputs a determination result from the control unit 21, and a negative result that both codes do not match with each other (step S4:NO), an error handling process to display an error message that the automatic connection has failed on the display unit 24, or to output beep sound from the speaker 27 is carried out (step S6), and a series of processing is finished.

Further, in the vehicle unit 3, the Bluetooth communications unit 36 carries out the following processing. That is, the Bluetooth communications unit 36 determines whether there is the vehicle unit 3 and the cellular phone 2 within the range of Bluetooth communication (step S11). When he worker carrying the cellular phone 2 approaches one of the vehicles, the Bluetooth communications unit 36 determines that the vehicle unit 3 and the cellular phone 2 are within the range of Bluetooth communication to (step S11:YES), and controls the control unit 31 to acquire a common code by reading the code from the memory unit 32, and transmits the code acquired from the memory unit 32 to the cellular phone 2 (step S12). In this case, the Bluetooth communications unit 36 transmits a common code to the cellular phone 2 by assigning a common code to the area of the name code which a user can arbitrarily set besides areas of a machinery ID and a profile classification.

Subsequently, the Bluetooth communications unit 36 determines whether a common code from the cellular phone 2 is received (step S13), and after determining that the common code from the cellular phone 2 is received (step S13:YES), the unit 36 controls the control unit 31 to determine whether the code received from the cellular phone 2, that is, the common code assigned to the cellular phone 2 which is within the range of Bluetooth communication, and the code from the memory unit 32 match with each other (step S14).

Then, the Bluetooth communications unit 36 inputs a determination result from the control unit 31, and an affirmative result that both codes match with each other (step S14:YES) leads to carrying out an automatic connection procedure (step S15), and a series of processing is finished. In contrast, when the Bluetooth communications unit 36 inputs a determination result from the control unit 31, and a negative result that both codes do not match with each other (step S14:NO), an error handling process to operate the LED display unit 37, or to output a warning sound from the speaker 35 (step S16) is carried out, and a series of processing is finished.

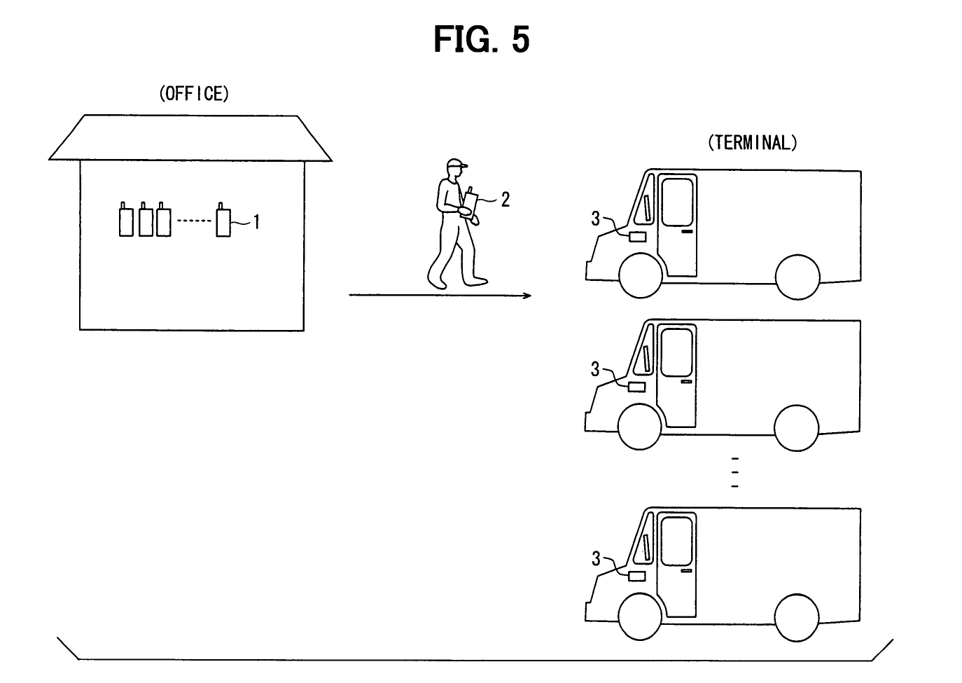

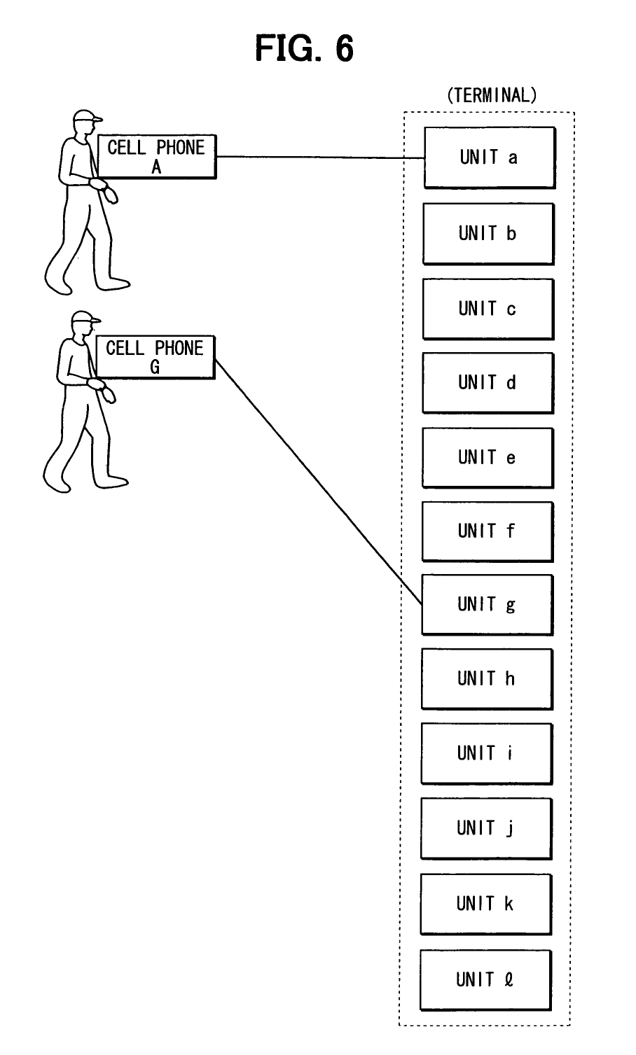

In other words, the worker chooses one of the plural cellular phones 2 in the office as shown in FIG. 5, and the chosen cellular phone 2 is carried by the worker into one of the trucks. That is, the worker picks up the cellular phone A that has the assigned common code of ‘001’ from among the twelve cellular phones A to L when he/she is assigned to use the truck having the vehicle unit a that has the assigned common code of ‘001’ as shown in FIG. 6. The worker only needs to approach the truck having the vehicle unit a from among the plural trucks in the truck yard with the cellular phone A for performing the automatic connection procedure without bothering a complicated connection procedure that prevents an erroneous connection. That is, the vehicle units b or c are not automatically connected to the cellular phone A without performing any operation of erroneous connection prevention.

In addition, when the worker picks up, for example, the cellular phone G that has the assigned common code of ‘007’ from among the twelve cellular phones A to L when he/she is assigned to use the truck having the vehicle unit g that has the assigned common code of ‘007.’ The worker only needs to approach the truck having the vehicle unit g from among the plural trucks in the truck yard with the cellular phone G for performing the automatic connection procedure without bothering a complicated connection procedure that prevents an erroneous connection. That is, the vehicle units a˜f or h˜I are not automatically connected to the cellular phone G without performing any operation of erroneous connection prevention.

Because each of the plural cellular phones 2 and each of the plural vehicle units 3 respectively have a common code assigned thereto in the administration service system 1 for performing the automatic connection procedure between the cellular phone 2 and the vehicle unit 3 having the matching common codes, a complicated connection procedure for preventing an erroneous connection is saved from being performed so as to accurately transmit the service management information acquired by the vehicle unit 3 to the center unit 5 through the wide area communications network from the cellular phone 2 based on an accurately established wireless communication between the vehicle unit 3 and the cellular phone 2.

### Second Embodiment

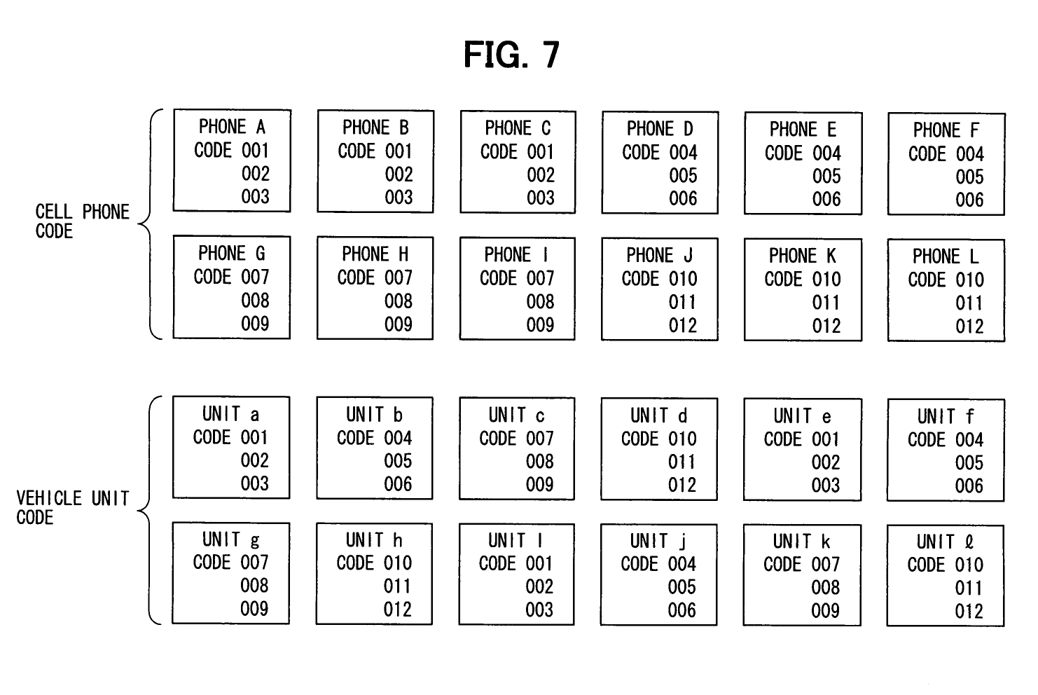

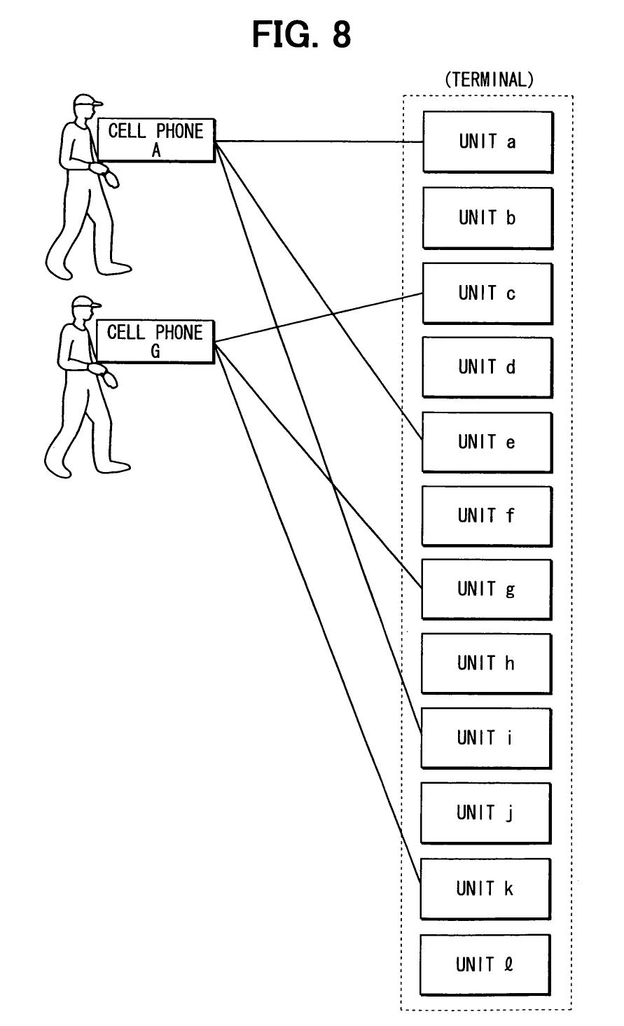

The second embodiment of the present invention is explained referring to FIGS. 7 and 8. The description of the present embodiment is focused on the difference between the first and the second embodiments. The configuration of the first embodiment mentioned above assigns each of the cellular phones 2 and each of the vehicle units 3 a common code for associating those components in one-to-one manner. However, in the second embodiment, the common codes are assigned to the cellular phones 2 and the vehicle units 3 in at least two-to-two manner or the like.

More practically, as shown in FIG. 7, among the twelve cellular phones A to L and the twelve vehicle units a to I, the cellular phones A to C and the vehicle units a,e,i have the common codes of ‘001’ ‘002’ and ‘003.’ Likewise, the cellular phones D to F and the vehicle units b,f,j have the common codes of ‘004’ ‘005’ and ‘006.’ Further, the cellular phones G to I and the vehicle units c,g,k have the common codes of ‘007’, ‘008’ and ‘009,’ and the cellular phones I to L and the vehicle units d,h,I have the common codes of ‘010’, ‘011’, and ‘012.’ That is, the respective cellular phones 2 and the vehicle units 3 have 3 codes, for establishing 3 to 3 association. In other words, twelve cellular phones A-L are grouped into four groups of three phones, and twelve vehicle units a-I are grouped into four groups of three units.

In this case, for example, the worker chooses one of the cellular phones A to C that have the common code ‘001’ assigned thereto when he/she is assigned to use the truck equipped with the vehicle unit a. Then, the worker approaches the truck in the truck yard with one of the cellular phones A to C for automatically connecting to the vehicle unit a in the course of approach to the truck having the vehicle unit a from among the plural trucks. That is, the worker has an increased chance of choosing the cellular phone 2 that has the assigned code of ‘001’ from among the twelve cellular phones A to L.

In another case, for example, the worker chooses one of the cellular phones G to I that have the common code ‘007’ assigned thereto when he/she is assigned to use the truck equipped with the vehicle unit g. Then, the worker approaches the truck in the truck yard with one of the cellular phones G to I for automatically connecting to the vehicle unit g in the course of approach to the truck having the vehicle unit g from among the plural trucks. That is, the worker has an increased chance of choosing the cellular phone 2 that has the assigned code of ‘007’ from among the twelve cellular phones A to L.

When the worker who has the assigned truck with the vehicle unit a which has the common code ‘001’ approaches the vehicle unit e or i prior to the approach to the truck with the vehicle unit a, one of the cellular phones A to C is automatically connected to the vehicle unit e or i prior to an automatic connection of one of the cellular phones A to C with the vehicle unit a. However, the worker's walk path in the truck yard, the truck's parking position in the truck yard, the Bluetooth communication range or the group number may be modified for avoiding such a situation. In other words, it should be adjusted so that no two vehicle units 3 with the same common code are arranged to be parking in the Bluetooth communication range.

The second embodiment of the present invention has the same effect as the first embodiment. Particularly, in the present embodiment, each of the plural cellular phones 2 has three common codes assigned thereto, with the corresponding common codes assigned to each of the plural vehicle units 3 for improved efficiency of establishing connection between the cellular phones 2 and the vehicle units 3.

### Other Embodiments

Although the present invention has been fully described in connection with the preferred embodiment thereof with reference to the accompanying drawings, it is to be noted that various changes and modifications will become apparent to those skilled in the art.

For example, the cellular phone may be substituted with a portable information terminal with a broad range communication function.

In addition, the function of the vehicle unit may be built into a navigation apparatus of well-known type. Further, the function of the vehicle unit may be a part of the vehicle's function depending on a type of ECU.

Furthermore, the correspondence of the common code may be two or more to one in each of the cellular phones 2 and each of the vehicle units. More practically, the three common codes ‘001’ ‘002’ and ‘003’ may be assigned to each of the cellular phones A to C with the assignment of the common code ‘001’ to the vehicle unit a, the code ‘002’ to the unit b, and the code ‘003’ to the unit c. In this manner, the chances of establishing wireless communication between the cellular phone 2 and the vehicle unit 3 are increased for an improvement of the work efficiency.

Furthermore, the correspondence of the common code may be one to two or more in each of the cellular phones 2 and each of the vehicle units. More practically, the common codes ‘001,’ ‘002’, and ‘003’ may be respectively assigned to the cellular phones A, B and C with the assignment of the three common codes ‘001’, ‘002° and ‘003’ to the each of the vehicle units a,e,j. In this manner, the chances of establishing wireless communication between the cellular phone 2 and the vehicle unit 3 are increased for an improvement of the work efficiency.

Furthermore, when two or more vehicle units 3 have a matching common code with one cellular phone 2, the display unit 24 of the cellular phone 2 may display a vehicle number of the vehicle units 3 on the two or more vehicles, and the worker may choose one of the vehicle units 3 for establishing the wireless communication.

The common codes may arbitrarily changed by the worker according to the increase/decrease of the vehicles.

Such changes and modifications are to be understood as being within the scope of the present invention as defined by the appended claims.

What is claimed is:

1. A system for vehicular short range wireless communication comprising:
a plurality of cellular phones respectively having a short range communication function; and
a plurality of vehicle units respectively having a short range communication function, wherein
one of the plurality of the cellular phones and one of the plurality of the vehicle units respectively existing in a short range communication range executes an automatic connection procedure for automatic connection based on configuration,
the plurality of the cellular phones and the plurality of the vehicle units respectively have a common code in common with a connection partner, and
the common code from the connection partner is examined and determined to be identical with the common code in a subject device before executing the automatic connection procedure with the connection partner.

2. The system of claim 1, wherein
each of the plurality of the cellular phones and each of the plurality of the vehicle units respectively have a common code that associates one of the plurality of the cellular phones with one of the plurality of the vehicle units in one-to-one correspondence.

3. The system of claim 1, wherein
each of the plurality of the cellular phones and each of the plurality of the vehicle units respectively have a common code that associates at least two pieces of the plurality of the cellular phones with one of the plurality of the vehicle units.

4. The system of claim 1, wherein
each of the plurality of the cellular phones and each of the plurality of the vehicle units respectively have a common code that associates one of the plurality of the cellular phones with at least two pieces of the plurality of the vehicle units.

5. The system of claim 1, wherein
each of the plurality of the cellular phones and each of the plurality of the vehicle units respectively have a common code that associates at least two pieces of the plurality of the cellular phones with at least two pieces of the plurality of the vehicle units.

6. The system of claim 4, wherein,
when the common code in each of the plurality of the cellular phones matches with the common code in at least two pieces of the plurality of the vehicle units, each of the plurality of the cellular phones performs the automatic connection procedure with one of the plurality of the vehicle unit that is selected by a worker

7. A cellular phone having a short range wireless communication function for use in a short range wireless communication system, wherein the short range wireless communication system is configured to automatically establish connect between one of a plurality of cellular phones having the short range wireless communication function and one a plurality of vehicle units having the short range wireless communication function respectively existing in a short range communication range after performing an automatic connection procedure, the cellular phone comprising:
a common code storage capable of storing a common code that is in common with at least one of the plurality of the vehicle units;
a common code reception unit capable of receiving the common code from one of the plurality of the vehicle units in the short range communication range;
a common code determination unit capable of determining that the common code received by the common code reception unit and the common code stored in the common code storage are matching; and
an automatic connection unit capable of performing the automatic connection procedure with the vehicle unit that has the matching common code when the common code determination unit determines that two common codes are matching.

8. A vehicle unit having a short range wireless communication function for use in a short range wireless communication system, wherein the short range wireless communication system is configured to automatically establish connect between one of a plurality of cellular phones having the short range wireless communication function and one a plurality of vehicle units having the short range wireless communication function respectively existing in a short range communication range after performing an automatic connection procedure, the vehicle unit comprising:
a common code storage capable of storing a common code that is in common with at least one of the plurality of the cellular phones;
a common code reception unit capable of receiving the common code from one of the plurality of the cellular phones in the short range communication range;
a common code determination unit capable of determining that the common code received by the common code reception unit and the common code stored in the common code storage are matching; and
an automatic connection unit capable of performing the automatic connection procedure with the cellular phone that has the matching common code when the common code determination unit determines that two common codes are matching.
